(19) United States
(12) Patent Application Publication
(10) Pub. No.: US 2006/0176253 A1
(43) Pub. Date: Aug. 10, 2006

(54) Driving apparatus and driving method of light emitting display panel

(75) Inventors: Naoki Yazawa, Yonezawa-shi (JP); Kazuhirio Satoh, Yonezawa-shi (JP); Shinobu Adachi, Yonezawa-shi (JP); Toshihiko Aoki, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 11/345,278

(22) Filed: Feb. 2, 2006

(30) Foreign Application Priority Data
Feb. 9, 2005 (JP) 2005-033417

(51) Int. Cl. G09G 3/32

(52) U.S. Cl. 345/82

(57) ABSTRACT

A measurement current whose value is lower compared to a light emission drive current If for allowing light emitting elements to emit light for display is supplied to an anode line, and a forward voltage value of the light emitting element of this time is obtained by a sample and hold circuit. This information is sent to a light emission control circuit, and the light emission control circuit obtains information corresponding to a forward voltage value of the light emitting element of when the light emission drive current is supplied to the light emitting element, out of a data table 11, based on information of the forward voltage value Vs. The output voltage VH of a DC-DC converter is controlled based on the information of this forward voltage value Vf.

### BACKGROUND OF THE INVENTION

1. Field of the Invention

The present invention relates to a technique for driving light emitting elements, such as for example organic EL (electroluminescent) elements, for light emission, and more particularly to a driving apparatus and a driving method of a light emitting display panel in which the display quality can be maintained at a certain level and in which the power consumption can be reduced when the light emitting display panel in which a large number of organic EL elements are arranged in a matrix is driven.

2. Description of the Related Art

Demand for a display panel which has a high definition image display function and which can realize a thin shape and low power consumption has increased due to popularity of cellular telephones, personal digital assistants (PDAs), and the like, and conventionally a liquid crystal display panel has been adopted in many products as a display panel which meets such needs. Meanwhile, these days a display panel employing organic EL (electroluminescent) elements whose characteristic as being a self light emitting type display element is best used has been put to practical use, and this have attracted attention as a next generation display panel in place of the conventional liquid crystal display panel. A background thereof is that by employing, in a light emission functional layer of the element, an organic compound by which an excellent light emission characteristic can be expected, a high efficiency and a long life by which practical use is possible have been advanced.

The above-described organic EL element is constructed for example by laminating a transparent electrode made of ITO, a light emission functional layer made of an organic material, and a metal electrode one by one basically on a transparent substrate such as of glass or the like. The light emission functional layer may be a single layer of an organic light emitting layer, or a two layer structure composed of an organic positive hole transport layer and an organic light emitting layer, or a three layer structure composed of an organic positive hole transport layer, an organic light emitting layer, and an organic electron transport layer, or a multilayer structure in which an injection layer of electrons or positive holes is inserted between appropriate layers among these layers.

The organic EL element can be electrically represented by an equivalent circuit as FIG. 1. That is, the organic EL element can be replaced by a structure composed of a diode component E as a light emitting component and a parasitic capacitance component Cp which is connected in parallel to this diode component E, and thus the organic EL element has been considered to be a capacitive light emitting element.

When a light emission drive voltage is applied to this organic EL element, at first, electrical charges corresponding to the electric capacity of this element flow into the electrode as a displacement current and are accumulated. It can be considered that when the drive voltage then exceeds a predetermined voltage (light emission threshold voltage=Vth) peculiar to this element, current begins to flow from an electrode (anode side of the diode component E) to an organic layer constituting a light emitting layer so that the element emits light at an intensity proportional to this current.

FIG. 2 shows light emission static characteristics of such an organic EL element. According to these, the organic EL element emits light at an intensity L approximately proportional to a drive current I as shown in FIG. 2A and emits light while the current I flows drastically when the drive voltage V is the light emission threshold voltage Vth or higher as shown by a solid line in FIG. 2B.

In other words, when the drive voltage is the light emission threshold voltage Vth or lower, current rarely flows in the EL element, and the EL element does not emit light. Therefore, the EL element has an intensity characteristic that in a light emittable region in which the drive voltage is higher than the threshold voltage Vth, the higher the value of the voltage V applied to the EL element, the higher the light emission intensity L thereof as shown by the solid line in FIG. 2C.

Meanwhile, it has been known that physical properties of the organic EL element change due to long-term use to cause forward voltage Vf to become higher. Thus, as shown in FIG. 2B, the I-V characteristic of the organic EL element changes in a direction shown by the arrow (characteristic shown by the broken line) due to actual use time, and therefore the intensity characteristic is also deteriorated.

Further, it has also been known that the intensity property of the organic EL element changes due to temperature changes roughly as shown by broken lines in FIG. 2C. That is, while the EL element has a characteristic that the higher the value of the voltage V applied thereto, the higher the light emission intensity L thereof in the light emittable region in which the drive voltage is higher than the light emission threshold voltage, the EL element also has a characteristic that the higher the temperature becomes, the lower the light emission threshold voltage becomes. Accordingly, the EL element has a temperature dependency that the higher the temperature becomes, the lower the applied voltage by which light emission becomes possible and that the EL element is brighter at a high temperature time and is darker at a lower temperature time though the same light emittable voltage is applied.

Furthermore, the EL element has a problem that the light emission efficiency with respect to the forward voltage differs in accordance with its emission color, and the light emission efficiencies of EL elements which emit lights of respective R (red), G (green), and B (blue) and which can be put to practical use in the present state are in a state of affairs in which the light emission efficiency of G is high and the light emission efficiency of R is the lowest roughly as shown in FIG. 2D. EL elements which emit lights of these R, G, and B respectively also have aging and temperature dependency as shown in FIGS. 2B and 2C.

The EL element also has a problem that the forward voltage Vf fluctuates even due to for example variations in deposition in the time of film formation of the element and with this fluctuation, variations in initial intensities occur, and thus it becomes difficult to express an intensity gradation faithful to an input video signal, that is, to maintain a display quality at a certain level.

Regarding the organic EL element, due to reasons that the voltage-intensity characteristic thereof is unstable with respect to temperature changes while the current-intensity characteristic thereof is stable with respect to temperature changes and that degradation of the element at a time of applying of an excess current is enormous, a constant current drive is performed in general. In this case, a drive voltage VH which is supplied from a power supply section for example constituted by a DC/DC converter to a constant current circuit has to be set in consideration of the following respective factors.

That is, as the factors, it is possible to enumerate the forward voltage Vf of the EL element, a variation part VB of the Vf of the EL element, an aging part VL of the Vf, a temperature change part VT of the Vf, a drop voltage VD necessary for allowing the constant current circuit to perform a constant current operation, and the like. Even when these factors interact synergistically, in order to fully ensure the constant current characteristic of the constant current circuit, the drive voltage VH has to be set at a value obtained by adding maximum values of respective voltages shown as the respective factors.

However, a case does not occur so frequently where the voltage value obtained by adding the maximum values of the respective voltages as described above is needed as the drive voltage VH supplied to the constant current circuit, and in a usual state, a large power loss as a voltage drop in the constant current circuit is brought about. Therefore, this becomes a primary factor of generation of heat, thereby putting stress on organic EL elements, peripheral circuit parts, and the like.

Thus, in order to avoid the above-described problem, the present applicant, et al. have already filed a patent application of a driving apparatus of a light emitting display panel in which the forward voltage Vf of the EL element is measured and in which the value of the drive voltage VH for driving the constant current circuit is controlled based on this forward voltage Vf to reduce the power loss generated in the constant current circuit and to ensure the display quality at a certain level, and this is disclosed in Japanese Patent No. 3390214, Japanese Patent Application Laid-Open No. 2002-229512, and Japanese Patent Application Laid-Open No. 2002-366101.

As means for measuring the forward voltage Vf of the EL element, as disclosed in Patent Documents 1 and 2, it may be contemplated to adopt means (first means) for utilizing an EL element which is arranged in a display panel to emit light for display and for extracting the forward voltage Vf thereof. Further, as disclosed in Patent Document 3, it may be contemplated to adopt means (second means) for utilizing a measurement element formed in a display panel other than EL elements which are arranged in the display panel to emit light for display and for extracting the forward voltage Vf of the measurement element.

In the case where the first means is adopted, with respect to a specific element which emits light for display, by forming in advance a circuit configuration such as an extraction line and the like through which the forward voltage Vf can be extracted, the forward voltage Vf can be obtained readily. However, in the case where the forward voltage Vf is obtained through the specific element which emits light for display, since it is necessary to supply a lighting drive current to this specific element, this element is brought to a light emitting state.

Therefore, in a mode in which the forward voltage Vf is measured, since a part of elements on the display panel abruptly irregularly performs a light emission operation, a problem occurs in that an end user who does not know such circumstances has a suspicion that such an operation corresponds to a malfunction or defect. In order to avoid such a problem, for example, it may be contemplated that the forward voltage Vf is measured during displaying of screen saver and that means for making the element's light emission resulting from the measurement of the forward voltage less prominent is adopted. Meanwhile, in the case of adopting such means, a screen saver of a display screen or the like imposes a restriction on an electronic equipment (assembly) maker in which this type of display panel is incorporated in the equipment, this situation is not preferred realistically.

Thus, although the problem generated by adopting the above-described first means can be resolved by adopting the above-described second means, by adopting this second means, another problem described below occurs. First, in order to arrange a measurement element on a panel, a space other than a display region is necessary a little bit. Further, in order to shade the light emission generated at the time of obtaining the forward voltage Vf through the measurement element, a problem occurs in that the necessity of forming a mask on an arrangement portion of the measurement element occurs. Therefore, these not only become a primary factor by which the size of a panel is increased but also become a primary factor by which the cost is increased in the fabrication process.

Moreover, in the case where the second means is adopted, a difference between the lighting ratios (lighting histories) of the measurement element and display element is generated with the passage of time, and light emission characteristics (I-V characteristics) of both elements dissociate from each other, so that a problem also occurs in that obtaining an appropriate forward voltage Vf of the display element becomes difficult.

### SUMMARY OF THE INVENTION

The present invention has been developed based on the above-described technical viewpoint, and it is an object of the present invention to resolve the above-described problems resulting from the measurement of the forward voltage Vf of the light emitting element and to provide a driving apparatus and a driving method of a light emitting display panel in which by constantly supplying an appropriate drive voltage to the display panel side, the utilization efficiency of electrical power can be improved and in which a certain level of display quality can be ensured.

A driving apparatus of a light emitting display panel according to the present invention which has been developed in order to resolve the problem is a driving apparatus of a light emitting display panel in which a plurality of light emitting elements are provided and in which by selectively supplying a light emission drive current which is based on video information to the light emitting elements, the video information is displayed, characterized in that the driving apparatus comprises: a measurement current supply means for supplying a measurement current Is whose value is lower compared to the light emission drive current If which is to allow the light emitting elements to emit light for display to the light emitting elements; forward voltage measurement means for obtaining a forward voltage value Vs of a light emitting element of when the measurement current Is supplied from the measurement current supply means is supplied to this light emitting element; estimation means for estimating a forward voltage value Vf of an light emitting element of when the light emission drive current If is supplied to this light emitting element based on the forward voltage value Vs obtained by the forward voltage measurement means; and power supply voltage control means for controlling an output voltage value of a voltage source which supplies the light emission drive current to the light emitting elements based on the forward voltage value Vf estimated by the estimation means.

A driving method of a light emitting display panel according to the present invention which has been developed in order to resolve the problem is a driving method of a light emitting display panel in which a plurality of light emitting elements are provided and in which by selectively supplying a light emission drive current which is based on video information to the light emitting elements, the video information is displayed, characterized in that the driving method executes: a measurement current supply step of supplying a measurement current Is whose value is lower compared to the light emission drive current If which is to allow the light emitting elements to emit light for display to the light emitting elements; a forward voltage measurement step of obtaining a forward voltage value Vs of a light emitting element of when the measurement current Is is supplied to this light emitting element in the measurement current supply step; an estimation step of estimating a forward voltage value Vf of an light emitting element of when the light emission drive current If is supplied to this light emitting element based on the forward voltage value Vs obtained in the forward voltage measurement step; and a voltage control step of controlling an output voltage value of a voltage source which supplies a light emission drive current to the light emitting elements based on the forward voltage value Vf estimated in the estimation step.

### BRIEF DESCRIPTION OF THE DRAWINGS

FIG. 1 is a view of an equivalent circuit of an organic EL element;

FIG. 2 is graphs of static characteristics showing various characteristics of the organic EL element;

FIG. 3 is a characteristic view of a light emitting element explaining a basic concept for realizing a driving apparatus according to the present invention;

FIG. 4 is similarly a characteristic view explaining a basic concept including aging and temperature dependency;

FIG. 5 is similarly a characteristic view explaining a basic concept of a case where light emitting elements having different emission colors are employed;

FIG. 6 is a circuit structure diagram showing a first embodiment of a driving apparatus according to the present invention;

FIG. 7 is a circuit structure diagram explaining a specific example of an anode line drive circuit in FIG. 6;

FIG. 8 is a circuit structure diagram showing a second embodiment of a driving apparatus according to the present invention; and

FIG. 9 is similarly a circuit structure diagram showing a third embodiment.

### DESCRIPTION OF THE PREFERRED EMBODIMENT

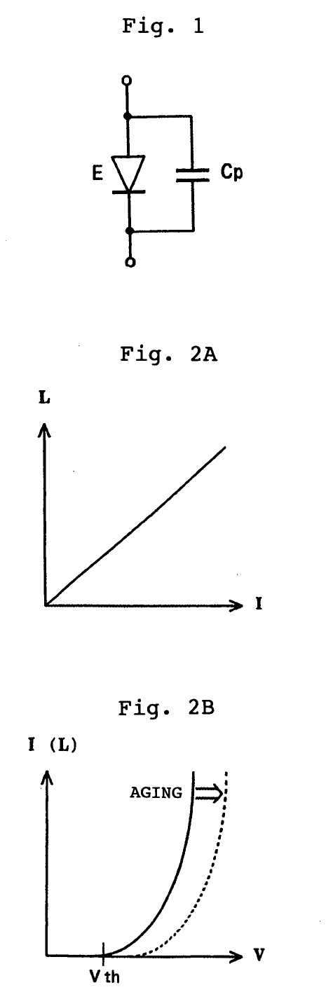

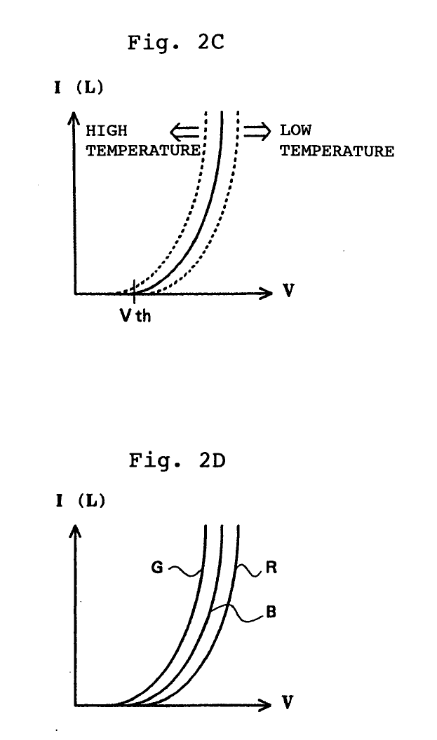

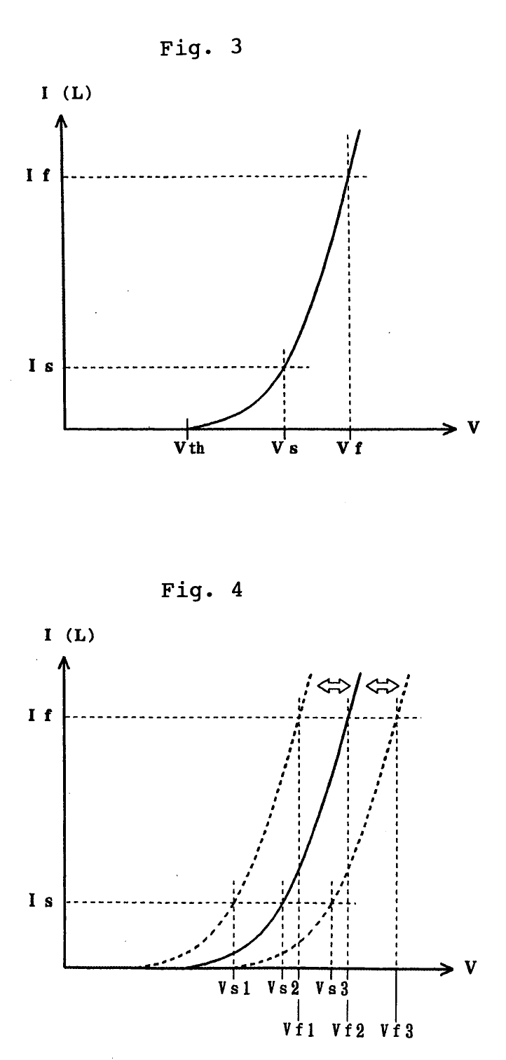

A driving apparatus and a driving method of a light emitting display panel according to the present invention will be described below based on embodiments shown in the drawings. FIG. 3 shows an I-V characteristic of an EL element explaining a basic concept for realizing the driving apparatus and driving method. The vertical axis and horizontal axis thereof show a relationship of a drive current I flowing in the EL element and a forward voltage V of this time, similarly to FIGS. 2B to 2D which have been already described.

In the driving apparatus and driving method according to the present invention, as shown in FIG. 3, executed is a process (measurement current supplying process) in which a measurement current Is whose value is lower compared to a light emission drive current If for allowing an EL element as a light emitting element to emit light is supplied to the EL element. The forward voltage value Vs of this element at the time of supplying of the measurement current Is to the EL element is allowed to be obtained. This process is called a forward voltage measurement process.

Then, based on the forward voltage value Vs obtained in the forward voltage measurement process, the forward voltage value Vf of this EL element at the time of supplying of the light emission drive current If to the EL element is estimated (estimation process). Based on the forward voltage value Vf estimated in this process, an operation is performed such that an output voltage value of a voltage source which gives a light emission drive current to the EL element is controlled (voltage control process).

The I-V characteristic of the EL element shown in FIG. 3 changes as shown by the broken lines from the solid line as shown in FIG. 4 due to aging and temperature dependency of the EL element. However, as described above, Vf1, Vf2, and Vf3 can be estimated from measurement values Vs1, Vs2, and Vs3, respectively, similarly in the I-V characteristic.

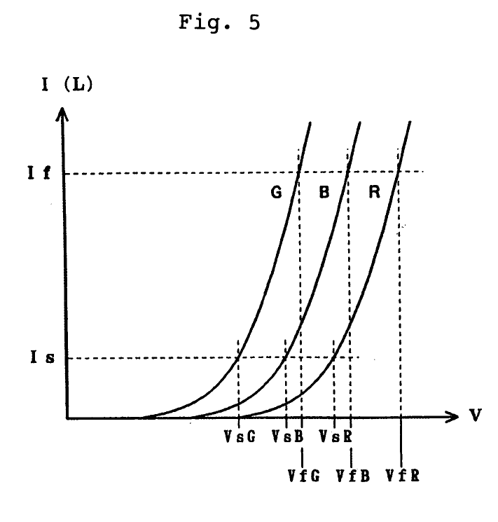

This is similar in respective EL elements which emit lights of R, G, and B whose light emission efficiencies are different as already described above, and VfG, VfB, and VfR can be estimated from measurement values VsG, VsB, and VsR, respectively, in the I-V characteristic, as shown in FIG. 5. EL elements which emit lights of these R, G, and B respectively also have aging and temperature dependencies, and by utilizing means which is similar to that in the example shown in FIG. 4, estimating the forward voltage value Vf on each occasion becomes possible.

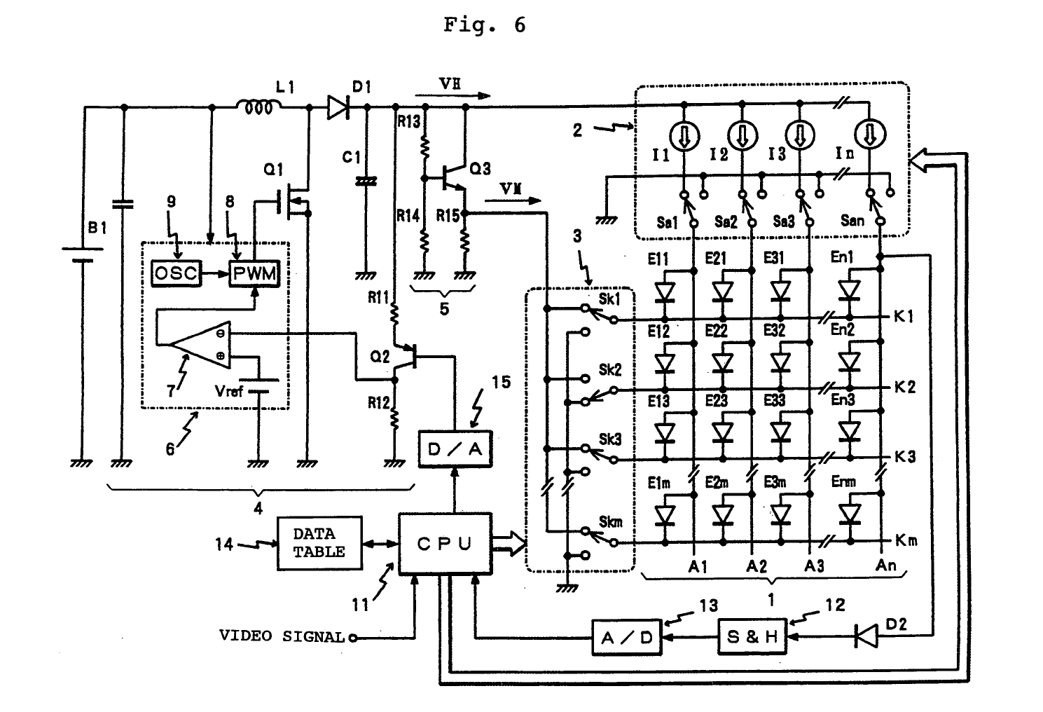

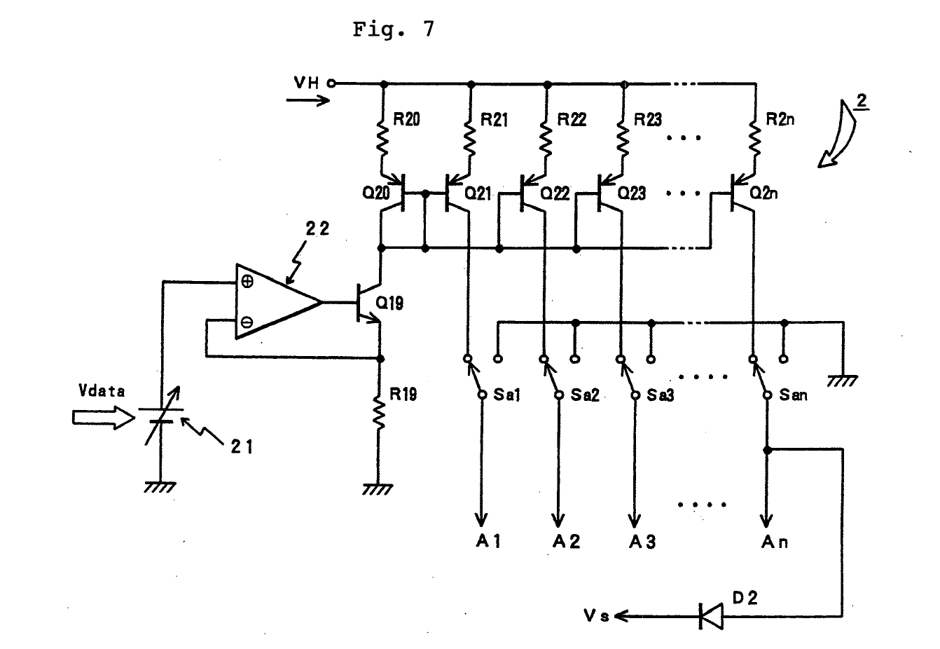

FIG. 6 is to explain a first embodiment constructed so that the above-described means is utilized to control an output voltage value of the voltage source, and shows an example in which it is adopted in a driving apparatus of a passive drive type display panel.

The driving method of EL elements in this passive matrix drive system includes two methods, that is, methods of cathode line scan/anode line drive and anode line scan/cathode line drive, and the structure shown in FIG. 6 shows a feature of the former cathode line scan/anode line drive. That is, n anode lines A1-An as supply lines are arranged in a vertical direction (column direction), m cathode lines K1-Km as scan lines are arranged in a horizontal direction (row direction), and organic EL elements E11-Enm represented by symbols of diodes are arranged at portions at which the anode lines intersect the cathode lines (in total, n×m portions) to construct a display panel 1.

In the respective EL elements E11-Enm constituting pixels, one ends thereof (anode terminals in the equivalent diodes of the EL elements) are connected to the anode lines and the other ends thereof (cathode terminals in the equivalent diodes of the EL elements) are connected to the cathode lines, corresponding to the respective intersection positions between the anode lines A1-An extending along the vertical direction and the cathode lines K1-Km extending along the horizontal direction. Further, the respective anode lines A1-An are connected to an anode line drive circuit 2 which is provided as a data driver, and the respective cathode lines K1-Km are connected to a cathode line scan circuit 3 similarly provided as a scan driver, so as to be driven respectively.

In the anode line drive circuit 2, provided are constant current sources I1-In which operate utilizing the output voltage VH supplied from a voltage boost circuit 4 in a DC-DC converter which is provided as a voltage source described later, and drive switches Sa1-San as switching means, and by allowing the drive switches Sa1-San to be connected to the constant current sources I1-In sides, current from the constant current sources I1-In is supplied to the respective EL elements E11-Enm arranged corresponding to the cathode lines. The drive switches Sa1-San are constructed so as to allow the respective anode lines to be connected to a ground potential GND provided as a reference potential point in a case where current from the constant current sources I1-In is not supplied to the respective EL elements.

On the other hand, in the cathode line scan circuit 3, scan switches Sk1-Skm are provided corresponding to the respective cathode lines K1-Km, so that either of a reverse bias voltage VM which functions as a non-scan-selection potential and which is provided from a later-described reverse bias voltage generation circuit 5 employed for preventing crosstalk light emission or the ground potential which functions as a scan selection potential is connected to a corresponding cathode line. Thus, by connecting the constant current sources I1-In with desired anode lines A1-An while a cathode line is set at the reference potential point (ground potential) at a predetermined cycle, the respective EL elements are allowed to emit light selectively.

In the example shown in FIG. 6, the DC-DC converter which functions as the voltage source is constructed so as to utilize PWM (pulse width modulation) control as the voltage boost circuit 4 to generate the output voltage VH of a direct current. This DC-DC converter is fabricated such that a MOS power FET Q1 as a switching element is controlled to be turned on at a predetermined duty cycle through a PWM wave outputted from a switching regulator circuit 6 constituting a part of the voltage boost circuit 4.

That is, by the ON operation of the power FET Q1, electrical energy from a DC voltage source B1 of the primary side is accumulated in an inductor L, and by an OFF operation of the power FET Q1, electrical energy accumulated in the inductor L1 is accumulated in a capacitor C1 via a diode D1. By the repeat of the ON/OFF operations of the power FET Q1, a boosted DC output can be obtained as a terminal voltage of the capacitor C1.

The DC output voltage is divided by a resistance element R11, a pnp transistor Q2, and a resistance element R12 to be supplied to an error amplifier 7 in the switching regulator circuit 6, and in this error amplifier 7, this output is compared with a reference voltage Vref. This comparison output (error output) is supplied to a PWM circuit 8, and feedback control is performed to hold the output voltage at a predetermined drive voltage VH by controlling the duty cycle of a signal wave provided from an oscillator 9.

Therefore, the output voltage VH by the DC-DC converter can be described as the following Equation 1 where the electrical resistance between the emitter and collector electrodes of the transistor Q2 is RQ2. That is, the output voltage VH of the converter is controlled in dependence on the electrical resistance between the emitter and collector electrodes of the transistor Q2.
VH=Vref×[(R11+RQ2+R12)/R12] (Equation 1)

The reverse bias voltage generation circuit 5 utilized for preventing the cross talk light emission is composed of a voltage divider circuit which divides the output voltage VH. That is, this voltage divider circuit is composed of resistance elements R13 and R14, an npn transistor Q3 functioning as an emitter follower, and an emitter resistance R15 so that the reverse bias voltage VM is obtained at the emitter of the transistor Q3.

Therefore, where the base-emitter voltage of the transistor Q3 is denoted by Vbe, the reverse bias voltage VM obtained by the voltage divider circuit can be shown as the following Equation 2, and the reverse bias voltage VM is dependent upon the value of the output voltage VH of the converter.
VM=VH×[R14/(R13+R14)]—Vbe (Equation 2)

In the embodiment shown in FIG. 6, a video signal (video information) is supplied to a light emission control circuit 11 including a CPU and the like, and control signals based on the video signal are supplied to the anode line drive circuit 2 and the cathode line scan circuit 3 from the light emission control circuit 11 via a control bus. Thus, the constant current sources I1-In are connected to desired anode lines while a cathode scan line is set at the ground potential (scan selection potential) at a predetermined cycle based on the video signal. Therefore, the respective EL elements selectively emit light, so that an image based on the video signal is displayed on the display panel 1.

In the state shown in FIG. 6, the second cathode line K2 is set at the ground potential GND to become in a scan state, and at this time the reverse bias voltage VM from the reverse bias voltage generation circuit 5 which is the non-scan selection potential is applied to the cathode lines K1, K3-Km of a non-scan state. Accordingly, the respective EL elements connected to intersection points between driven anode lines and cathode lines which are not selectively scanned are prevented from emitting crosstalk light.

On the other hand, the embodiment shown in FIG. 6 is constructed such that, from a part of supply lines in the display panel 1, that is, from the nth anode line An, the electrical potential of this anode line can be extracted. Further, the structure shown in FIG. 6 is fabricated such that the electrical potential at the nth anode line An is supplied to a sample and hold circuit 12 via a backflow prevention diode D2.

The voltage obtained by the sample and hold circuit 12 is to hold the forward voltage value Vs which is generated at the time when the measurement current Is whose value is lower compared to the light emission drive current If is supplied to the EL element, as described later in detail. Thus, in order to avoid the influence of the threshold voltage of the backflow prevention diode D2, it is preferred that a synchronization detector circuit is utilized in place of the diode D2.

The voltage held by the sample and hold circuit 12 is converted into digital data in an A/D converter circuit 13 to be supplied to the light emission control circuit 11. The light emission control circuit 11 is constructed so as to be capable of reading out of a data table 14 output voltage control data which corresponds to the forward voltage Vf generated when the light emission drive current If is supplied to EL elements, based on the digital data. The output voltage control data read out of the data table 14 is converted into an analog value by a D/A converter circuit 15 to be supplied to the base electrode of the transistor Q2 constituting the DC-DC converter.

FIG. 7 shows a more specific circuit structure of the anode line drive circuit 2 shown in FIG. 6, and in the structure shown in this FIG. 7, constructed is switching means through which current supplied from the constant current sources to the anode lines A1-An which are provided as respective supply lines can be switched, for being outputted, between the light emission drive current If for driving EL elements for light emission and the measurement current Is whose value is low. That is, in the structure shown in FIG. 7, the control data (Vdata) is supplied from the light emission control circuit 11 to a positive terminal represented by a variable voltage source 21, and this is inputted to the non-inverting input terminal of an operational amplifier 22.

The output terminal of the operational amplifier 22 is connected to the base electrode of an npn transistor Q19, and the emitter electrode of this transistor Q19 is connected to the inverting input terminal of the operational amplifier 22 and the ground potential GND via a resistor 19. That is, the operational amplifier 22 and the transistor Q19 constitute voltage-to-current conversion means to operate to change the amount of current flowing in the transistor Q19 in response to the control data (Vdata) from the light emission control circuit 11.

On the other hand, between the output voltage line VH from the DC/DC converter and the collector electrode of the transistor Q19, the emitter and collector electrodes of a pnp transistor Q20 are connected via a resistor 20. The base and collector electrodes of the transistor Q20 are short circuited to each other, and the base potential of the transistor Q20 is provided to the respective base electrodes of pnp transistors Q21-Q2n. The emitter electrodes of the respective transistors Q21-Q2n are connected to the voltage line VH via resistors R21-R2n, respectively. Thus, a current mirror circuit is constructed in that the transistor Q20 is a controlling side current source and that the respective transistors Q21-Q2n are controlled side current sources.

Therefore, by allowing the collector current of the transistor Q20 which functions as the controlling side current source to be controlled to be changed through the control data (Vdata) represented by the variable voltage source 21, the collector current of the respective transistors Q21-Q2n are controlled to be changed respectively. In short, the respective transistors Q21-Q2n function as the constant current sources I1-In shown in FIG. 6, and the collector currents of the transistors Q21-Q2n are supplied to the anode lines A1-An provided as supply lines via the drive switches Sa1-San, respectively.

In the structure shown in FIGS. 6 and 7, when the display panel 1 is controlled to emit light based on the video signal, the light emission control circuit 11 provides control data (Vdata) which has a higher voltage level to the operational amplifier 22. Thus, the light emission drive current If which can drive EL elements for light emission is supplied to the respective anode lines A1-An.

Meanwhile, the light emission control circuit 11 periodically executes an operation in which the forward voltage Vf of an EL element arranged in the display panel 1 is measured. In this case, the light emission control circuit.11 provides the control data (Vdata) which has a low voltage level to the operational amplifier 22. Thus, the measurement current Is whose value is low compared to the light emission drive current If is supplied to the respective anode lines A1-An through the operation of the current mirror circuit. Thus, at this time, the current mirror circuit shown in FIG. 6 constitutes a measurement current supply means.

In this case, since the second scan line K2 is in the scan state as shown in FIG. 6, the sample and hold circuit 12 can obtain the forward voltage Vs of the EL element En2 which is connected between the second scan line K2 and the nth supply line (anode line) An. Thus, the sample and hold circuit 12 functions as forward voltage measurement means for obtaining the forward voltage value Vs of an EL element of the time when the measurement current Is is supplied to this EL element.

The forward voltage value Vs held in the sample and hold circuit 12 is converted into digital data in the A/D converter 13 to be supplied to the light emission drive circuit 11. The light emission drive circuit 11 operates to read out of the data table 14so that the output voltage control data which corresponds to the forward voltage value Vf of an EL element of the time when the light emission drive current If is supplied to the EL element based on the digital data corresponding to the forward voltage Vs.

In this case, the data table 14 is constructed such that, for example, for each R, G, and B, the output voltage control data which corresponds to the forward voltage Vf of when the light emission drive current If which corresponds to the forward voltage Vs is supplied can be extracted. Thus, the combination of the data table 14 and the light emission drive circuit 11 functions as estimation means for estimating the forward voltage Vf of when the light emission drive current If is supplied to the EL element.

The output voltage control data which corresponds to the forward voltage Vf extracted from the data table 14 is converted into an analog value by the D/A converter 15 to be supplied to the base electrode of the transistor Q2 constituting the DC-DC converter. Thus, the electrical resistance between the emitter and collector electrodes of the transistor Q2 is controlled, and the output voltage value VH of the converter is controlled based on Equation 1 already shown. That is, the DC-DC converter and the transistor Q2 which is interposed in the voltage divider circuit for feedback of the DC-DC converter functions as power supply voltage control means.

With the structure shown in FIGS. 6 and 7, through the forward voltage Vs which is generated at the time when the measurement current Is whose value is lower compared to the light emission drive current If of the EL element is supplied to the EL element, the forward voltage value Vf of the time of supplying the light emission drive current If is allowed to be estimated. Since operation is performed such that the output voltage value VH of the voltage source is controlled, utilizing this estimated forward voltage value Vf, the output voltage value VH constantly having an appropriate value which corresponds to the temperature dependency and aging of the EL element can be provided from the DC-DC converter which is installed as the voltage source.

Thus, a light emitting display panel can be provided in which the display quality can be maintained at a certain level, without causing a large power loss in the constant current sources I1-In. Moreover, since the forward voltage value Vf is found by supplying the measurement current Is whose value is lower than the light emission drive current If, utilizing the EL element employed for light emitting display, the problem that an EL element is lit irregularly at the time of measurement of the forward voltage can be resolved.

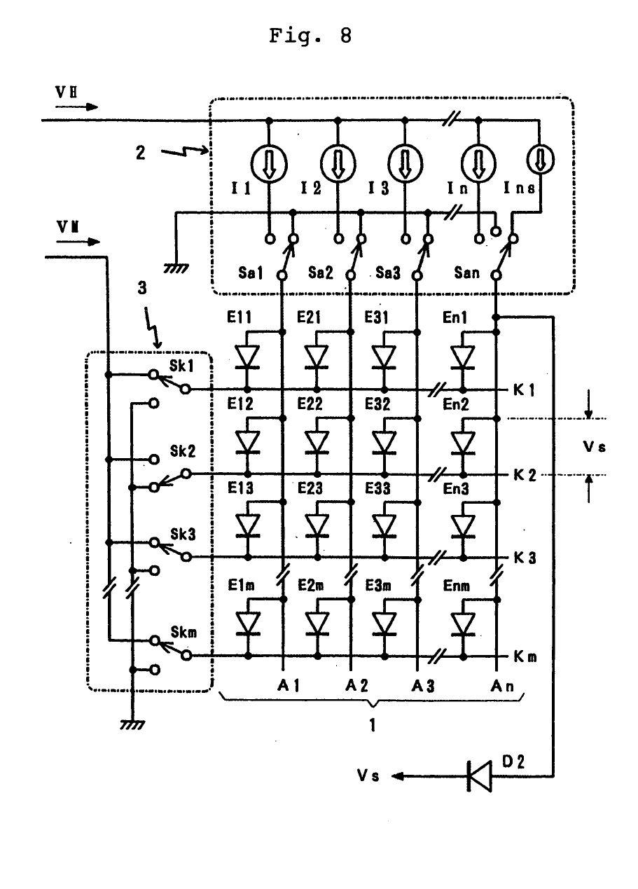

FIG. 8 shows a second embodiment according to the present invention and shows an example in which the present invention is adopted in a driving apparatus of a passive drive type display panel similarly. This FIG. 8 shows parts corresponding to the display panel 1, the anode line drive circuit 2, and the cathode line scan circuit 3 shown in FIG. 6, and since other structures are the same as those shown in FIG. 6, they are omitted in the drawing. Further, in this FIG. 8, parts corresponding to respective parts in FIG. 6 are denoted by the same reference characters, and therefore detailed description thereof will be omitted.

In the embodiment shown in FIG. 8, other than the constant current sources I1-In which are for driving respective EL elements for lighting, a constant current source Ins as a measurement current supply means which can supply the measurement current Is is provided. The structure shown in FIG. 8 is constructed such that the light emission drive current If provided from the constant current source In or the measurement current Is provided from the constant current source Ins can be selectively switched to be supplied to the nth anode line An provided as a supply line by means of the drive switch San which functions as switching means.

Therefore, in the case where the second scan line K2 is brought to the scan state as shown in FIG. 8, the forward voltage Vs of the EL element En2 which is connected between the second scan line K2 and the nth supply line (anode line) An can be obtained via the diode D2. Thus, similarly to the interaction described based on FIG. 6, it is possible to estimate the forward voltage value Vf of the time of supplying the light emission drive current If by the forward voltage value Vs of the time of supplying the measurement current Is to an EL element and to control the output voltage value VH of the voltage source, utilizing this estimated forward voltage value Vf. Accordingly, even in the embodiment shown in FIG. 8, operations and effects similar to those of the embodiment shown in FIGS. 6 and 7 can be obtained.

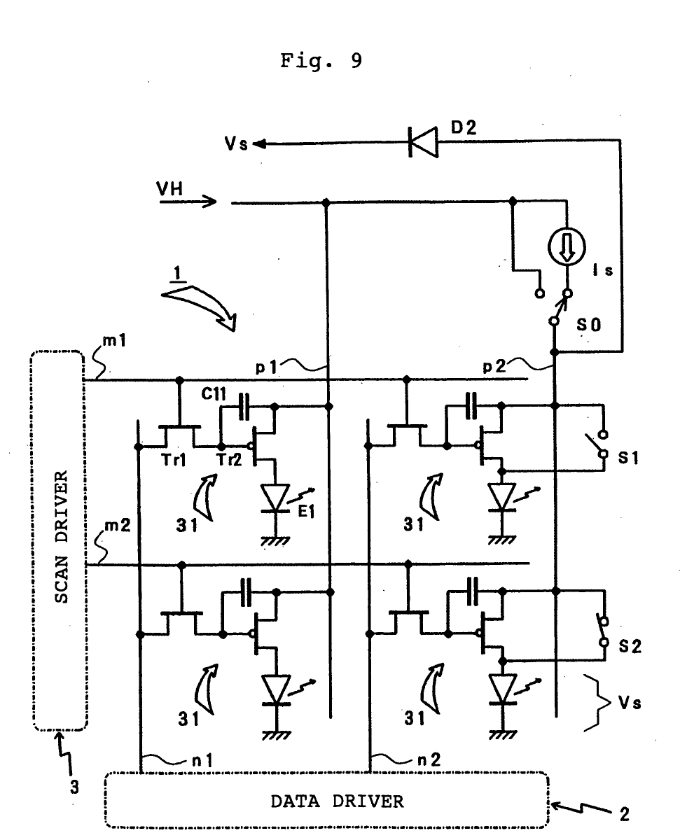

FIG. 9 shows a third embodiment according to the present invention and shows an example in which the present invention is adopted in a driving apparatus of an active drive type display panel. In this FIG. 9, parts which achieve functions similar to those of the structure shown in FIG. 6 are denoted by the same reference characters, and as other structures which are not shown in FIG. 9 and which include the DC-DC converter and the like, the structures shown in FIG. 6 can be adopted as they are.

In FIG. 9, in the light emitting display panel represented by reference numeral 1, display pixels 31 are arranged in a matrix in the vertical and horizontal directions. In FIG. 9, regarding the display pixels 31 arranged in a matrix, for convenience of illustration, two pixels in the respective vertical and horizontal directions, that is, four pixels in total, are shown.

In the light emitting display panel 1, data lines n1, n2, . . . on which a data signal is supplied from the data driver 2 and scan lines m1, m2, . . . on which a scan selection signal is supplied from the scan driver 3 are arranged in the vertical and horizontal directions, respectively. Further, in the display panel 1, power supply lines p1, p2, . . . as supply lines are arranged in the vertical direction, corresponding to the respective data lines, and the display panel 1 is constructed such that the output voltage VH from the DC-DC converter as the voltage source already described is supplied via these power supply lines p1, p2, In the example shown in FIG. 9, as the display pixels 31 arranged in the display panel 1, a pixel structure by a conductance control method is shown. That is, as shown in the pixel 31 of the upper left shown in FIG. 9 in which reference characters are shown for respective components constituting the pixel 31, a gate of a control transistor Tr1 constituted by an n-channel type TFT (thin film transistor) is connected to the scan line m1, and the source thereof is connected to the data line n1. The drain of the control transistor Tr1 is connected to the gate of a drive transistor Tr2 constituted by a p-channel type TFT and to one terminal of a charge-retaining capacitor C11.

The source of the drive transistor Tr2 is connected to the other terminal of the capacitor C11 and to the power supply line p1 provided as a supply line. The anode terminal of the EL element E1 is connected to the drain of the drive transistor Tr2, and the cathode terminal of this EL element E1 is connected to the reference potential point (ground potential).

In the pixel structure described above, when an ON voltage is supplied from the scan driver 3 to the gate of the control transistor Tr1 via the scan line m1, the control transistor Tr1 allows current corresponding to the data voltage which is supplied from the data line n1 to the source thereof to flow from the source to the drain. Accordingly, during the time when the gate of the control transistor Tr1 is at the ON voltage, the capacitor C11 is charged, and the voltage thereof is supplied to the gate of the drive transistor Tr2.

Therefore, the drive transistor Tr2 allows the light emission drive current If which is based on the gate voltage and the source voltage (Vgs) thereof to flow in the EL element E1 to drive the EL element for light emission. That is, in this embodiment, the drive transistor Tr2 constituted by a TFT operates in a saturation region, and by allowing the EL element E1 to be driven by a constant current, the EL element E1 is driven for light emission.

When the gate of the control transistor Tr1 becomes an OFF voltage, this transistor becomes so-called cutoff. Although the drain of the control transistor Tr1 becomes in an open state, the gate voltage in the drive transistor Tr2 is maintained by electrical charges accumulated in the capacitor C11, so that the light emission drive current is maintained until a next scan, and thus the light emission of the EL element E1 is also maintained.

In the structure shown in FIG. 9, the constant current source (measurement current supply means) Is which can supply the measurement current Is to a part of EL elements arranged on the display panel 1 is provided. That is, in the embodiment shown in FIG. 9, the constant current source Is is constructed so as to supply the measurement current to the power supply line p2 via a switch SO which functions as switching means.

On the other hand, in the structure shown in FIG. 9, in respective pixels connected to the power supply line p2 to which the measurement current Is is supplied, switches S1, S2, . . . as short-circuit means which can electrically short circuit the source and drain of each drive transistor Tr2 are connected between both electrodes. The switch S0 supplying the measurement current from the constant current source Is to the power supply line p2 and the switches S1, S2, . . . which selectively short circuit between the source and drain of each drive transistor Tr2 are operated through a command from the light emission control circuit 11 including the CPU shown in FIG. 6.

FIG. 9 shows a state in which the measurement current from the constant current source Is is supplied to the power supply line p2 via the switch S0 and in which the switch S2 is short circuited. With this state, the measurement current is supplied to an EL element constituting a pixel of the lower right shown in FIG. 9, and the forward voltage Vs of the EL element of this time is generated at the power supply line p2. Accordingly, the forward voltage Vs of the EL element can be obtained via the diode D2.

This forward voltage Vs is held by the sample and hold circuit 12 as described with reference to FIG. 6, and as a result, operates to control the output voltage value VH of the DC-DC converter. Accordingly, even in the driving apparatus of the active drive type display panel shown in FIG. 9, operations and effects similar to those of the embodiment shown in FIGS. 6 and 7 can be obtained.

The embodiments described above are constructed such that the forward voltage Vs of an EL element of the time of supplying the measurement current Is is extracted from one supply line (the anode line An in FIGS. 6 and 8, and the power supply line p2 in FIG. 9) arranged in the display panel. However, in implementing the present invention, the forward voltage Vs may be extracted appropriately not only from the above-described one supply line but also from other plurality of supply lines.

In the embodiment shown in FIG. 9, although a pixel structure of a conductance control method in which respective two TFTs are provided is exemplified as a display pixel, other lighting drive type pixel structures may be adopted of course. Further, although the embodiments described above show examples in which organic EL elements are employed as light emitting elements arranged in a display panel, similar operations and effects can be obtained even in a case where other light emitting elements having aging and temperature dependency as shown in FIG. 2 are employed.

What is claimed is:

1. A driving apparatus of a light emitting display panel in which a plurality of light emitting elements are provided and in which by selectively supplying a light emission drive current which is based on video information to the light emitting elements, the video information is displayed, the driving apparatus comprising:
a measurement current supply means for supplying a measurement current Is whose value is lower compared to the light emission drive current If which is to allow the light emitting elements to emit light for display to the light emitting elements;
forward voltage measurement means for obtaining a forward voltage value Vs of the light emitting element of when the measurement current Is supplied from the measurement current supply means is supplied to the light emitting element;
estimation means for estimating a forward voltage value Vf of the light emitting element of when the light emission drive current If is supplied to this light emitting element based on the forward voltage value Vs obtained by the forward voltage measurement means; and
power supply voltage control means for controlling an output voltage value of a voltage source which supplies the light emission drive current to the light emitting elements based on the forward voltage value Vf estimated by the estimation means.

2. The driving apparatus of the light emitting display panel according to claim 1, wherein the forward voltage measurement means is constructed in such a way that a voltage value generated on a supply line is obtained as the forward voltage value Vs when the measurement current Is is supplied to this supply line through which the light emission drive current If is supplied to the light emitting elements.

3. The driving apparatus of the light emitting display panel according to claim 1, wherein in a driving apparatus of a passive drive type display panel which further comprises a non-scan selection power source for supplying a non-scan selection potential to the light emitting elements of a non-scan state, the non-scan selection potential is controlled based on a forward voltage value Vf obtained by the estimation means.

4. The driving apparatus of the light emitting display panel according to claim 2, wherein in a driving apparatus of a passive drive type display panel which further comprises a non-scan selection power source for supplying a non-scan selection potential to the light emitting elements of a non-scan state, the non-scan selection potential is controlled based on a forward voltage value Vf obtained by the estimation means.

5. The driving apparatus of the light emitting display panel according to any one of claims 1 to 4, wherein in a driving apparatus of a passive drive type display panel in which scan lines to which the light emitting elements are connected are sequentially set at a scan selection potential and in which the light emission drive current If is supplied from a constant current source which operates by an output voltage supplied from the voltage source to a supply line to which a light emitting element which is to be controlled for light emission is connected, the driving apparatus comprising switching means by which the light emission drive current If of the constant current source and the measurement current Is from the measurement current supply means are selectively switched to be supplied to the supply line.

6. The driving apparatus of the light emitting display panel according to any one of claims 1 to 4, wherein in a driving apparatus of a passive drive type display panel in which scan lines to which the light emitting elements are connected are sequentially set at a scan selection potential and in which the light emission drive current If is supplied from a constant current source which operates by an output voltage supplied from the voltage source to a supply line to which a light emitting element which is to be controlled for light emission is connected, the constant current source works also as the measurement current supply means, and current values corresponding to the light emission drive current If and the measurement current Is are selectively switched to be supplied to the supply line.

7. The driving apparatus of the light emitting display panel according to claim 2, wherein in a driving apparatus of an active drive type display panel in which each light emission drive transistor is provided corresponding to the each light emitting element and in which the light emission drive current If is supplied to the respective light emitting elements via the light emission drive transistors, a short-circuit means for electrically short circuit the source and drain electrodes of the light emission drive transistor is operated when the measurement current Is is supplied to the supply line so that a voltage value generated on the supply line is obtained as the forward voltage value Vs.

8. The driving apparatus of the light emitting display panel according to any one of claims 1, 2 and 7, wherein in a driving apparatus of an active drive type display panel in which each light emission drive transistor is provided corresponding to the each light emitting element and in which the light emission drive current If is supplied to the respective light emitting elements via the light emission drive transistors, the driving apparatus comprises switching means by which the output voltage from the voltage source and the measurement current Is from the measurement current supply means are selectively switched to be supplied to the supply line.

9. The driving apparatus of the light emitting display panel according to claim 1, wherein the light emitting element is an organic EL element which includes at least one layer of a light emission functional layer made of an organic material.

10. A driving method of a light emitting display panel in which a plurality of light emitting elements are provided and in which by selectively supplying a light emission drive current which is based on video information to the light emitting elements, the video information is displayed, the driving method executing:
a measurement current supply step of supplying a measurement current Is whose value is lower compared to the light emission drive current If which is to allow the light emitting elements to emit light for display to the light emitting elements;
a forward voltage measurement step of obtaining a forward voltage value Vs of a light emitting element of when the measurement current Is is supplied to the light emitting element in the measurement current supply step;
an estimation step of estimating a forward voltage value Vf of an light emitting element of when the light emission drive current If is supplied to this light emitting element based on the forward voltage value Vs obtained in the forward voltage measurement step; and
a voltage control step of controlling an output voltage value of a voltage source which supplies a light emission drive current to the light emitting elements based on the forward voltage value Vf estimated in the estimation step.
